(19) United States
(12) Patent Application Publication
(10) Pub. No.: US 2013/0160126 A1
(43) Pub. Date: Jun. 20, 2013

(54) MALWARE REMEDIATION SYSTEM AND METHOD FOR MODERN APPLICATIONS

(71) Applicants: Vishal Kapoor, Seattle, WA (US); Jason J. Joyce, Redmond, WA (US); Gregory W. Nichols, Bellevue, WA (US); Joshua W. Dunn, Maple Valley, WA (US); Michael S. Jarrett, Kirkland, WA (US); Adrian M. Marinescu, Sammamish, WA (US); Marc E. Seinfeld, Fort Lauderdale, FL (US); Axel Andrejs, Sammamish, WA (US); Jayaraman Kalyana Sundaram, Redmond, WA (US)

(72) Inventors: Vishal Kapoor, Seattle, WA (US); Jason J. Joyce, Redmond, WA (US); Gregory W. Nichols, Bellevue, WA (US); Joshua W. Dunn, Maple Valley, WA (US); Michael S. Jarrett, Kirkland, WA (US); Adrian M. Marinescu, Sammamish, WA (US); Marc E. Seinfeld, Fort Lauderdale, FL (US); Axel Andrejs, Sammamish, WA (US); Jayaraman Kalyana Sundaram, Redmond, WA (US)

(73) Assignee: MICROSOFT CORPORATION, Redmond, WA (US)

(21) Appl. No.: 13/327,223

(22) Filed: Dec. 15, 2011

(51) Int. Cl. G06F 21/00; G06F 15/16

(52) U.S. Cl. 726/24

(57) ABSTRACT

A system is described for remediating a malicious modern application installed on an end user device. In an embodiment, the system includes an antimalware program executing on the end user device that can detect and attempt to remediate the malicious modern application, an operating system executing on the end user device that is configured to interact with the antimalware program for the purpose of facilitating the establishment of a connection between the end user device and an application support system in response to determining that the antimalware program has detected and attempted to remediate the malicious modern application, and the application support system that can perform remediation operations beyond those that can be performed by the antimalware program.

### BACKGROUND

A new application model has recently emerged in relation to the development, distribution, and deployment of software applications. In accordance with this model, applications are developed and uploaded to a centralized entity and then distributed from the centralized entity to multiple end user devices for installation and execution thereon. The centralized entity may comprise, for example, a cloud-based application distribution system (sometimes referred to as an “application store” or “app store”) that distributes applications to end user devices via a network infrastructure, although this is only one example.

This new application model differs from prior application models in a number of significant ways. For example, in accordance with the new application model, an application may be distributed to an end user device as part of digitally-signed application package. Such an application package may include the application code, an image that may be used to represent the application in the context of a graphical user interface (GUI), resources that may be used by the application, a manifest that describes the application, or the like. If an application package does not pass digital signature checking at install or runtime, an end user device may not execute the application. In further accordance with this application model, the application package may be installed in a fixed location on the end user device and managed as a unified whole. If this installation is tampered with or modified, then the end user device may not execute the application. Prior application models did not utilize such application packages or handle them in such a manner.

Applications that are developed to accord to this new application model will be referred to herein as “modern applications.” Generally speaking, conventional antimalware programs are not well-suited to remediate a modern application that has become infected with malware or is itself malware. This is due, in part, to the fact that conventional antimalware programs typically rely on file-based remediation. That is to say, such conventional antimalware programs may delete an infected application file or modify the file so that malware included therein is rendered harmless. If the application is a modern application, then this file deletion or modification may render the modern application inoperable and/or cause the application's package to fail digital signature checking on the end user device, thereby leaving the application in a non-functioning state.

Furthermore, the centralized entity that distributes a modern application may be the only entity that is actually capable or fully repairing and/or issuing a refund for the application should the application be determined to be infected. Additionally, providing information about the malicious application to the centralized entity may be critical to help such entity avoid distributing malicious applications to other end user devices. However, traditional antimalware programs have no concept of such a centralized entity and thus cannot possibly interact with such an entity to achieve these ends. Indeed, since such traditional antimalware programs cannot interact with such a centralized entity, these programs cannot provide a holistic and complete user experience in relation to the remediation of malicious modern applications.

Recent outbreaks of malware in various online marketplaces for modern applications have brought into focus the need for a remediation solution for modern applications which heretofore has not existed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

A method is described herein for performing malware remediation of an application that is installed on an end user device. In accordance with the method, an operating system executing on the end user device receives an indication that at least one component of an application package of which the application is a part is malicious and, in response to receiving the indication, facilitates the establishment of a connection to a designated entity via a network for the purpose of remediating the application.

A system is also described herein. The system includes an application support system implemented on one or more computers and an end user device. The end user device is capable of detecting when at least one component of an application package associated with an application installed on the end user device is malicious and of automatically establishing a connection to the application support system via a network in response to detecting that the at least one component of the application package is malicious. The application support system is configured to remediate the application subsequent to the establishment of the connection.

A computer program product is also described herein. The computer program product includes a computer-readable storage device having computer program logic recorded thereon. The computer program logic includes first computer program logic and second computer program logic. The first computer program logic is executable by a processing unit to scan a plurality of components of an application package associated with an application to determine if the application is malicious. The second is executable by the processing unit to notify an operating system when it is determined that the application is malicious, thereby enabling the operating system to transmit at least one report about the malicious application to a remote application support system and/or interact with the remote application support system for the purposes of remediating the malicious application.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 is a block diagram of an example system that provides for remediation of a malicious application that has been installed on an end user device in accordance with an embodiment.

FIG. 2 depicts a flowchart of a remediation process in accordance with an embodiment that may occur when a malicious application that is installed on an end user device is launched by a user thereof.

FIG. 3 depicts a flowchart of a generalized process for performing malware remediation of a modern application that is installed on an end user device in accordance with an embodiment.

FIG. 4 depicts a flowchart of a package-level caching process that may be used to improve the performance of an antimalware program executing on an end user device in accordance with an embodiment.

FIG. 5 depicts a flowchart of a method that may be executed by a computer-implemented system for remediating a malicious modern application in accordance with an embodiment.

FIG. 6 depicts a flowchart of a method that may be performed by an antimalware program for remediating a malicious modern application in accordance with an embodiment.

FIG. 7 is a block diagram of an example computer system that may be used to implement various embodiments described herein.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example System for Performing Malware Remediation of Modern Applications

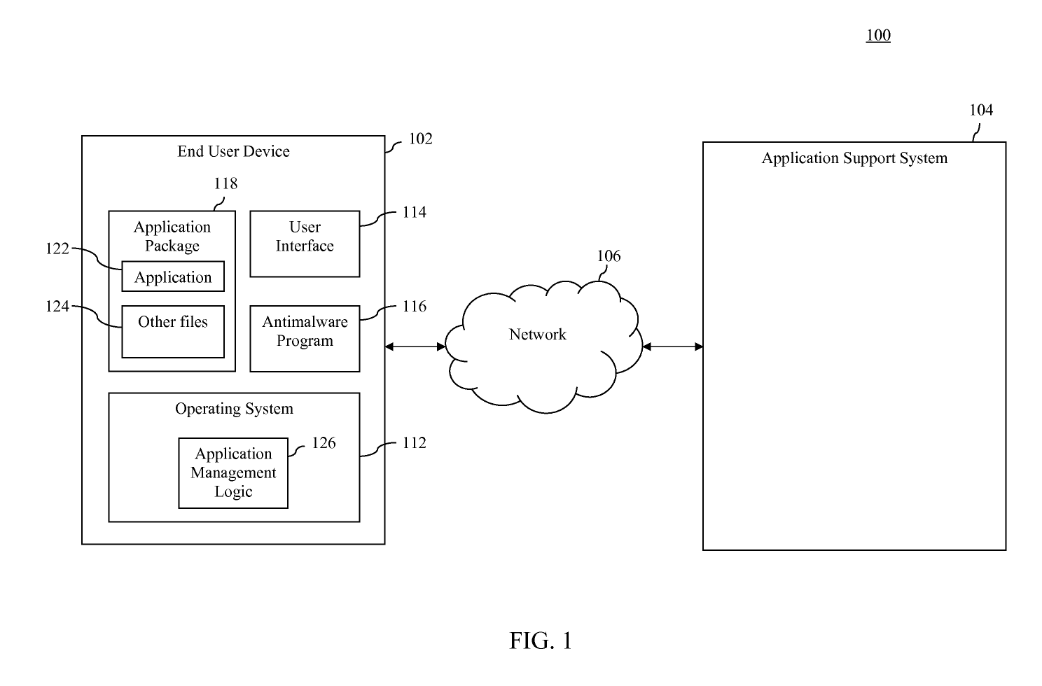

FIG. 1 is a block diagram of an example system 100 that provides for remediation of a malicious application that has been installed on an end user device in accordance with an embodiment. As shown in FIG. 1, system 100 includes at least one end user device 102 that can be communicatively connected to an application support system 104 via a network 106. Each of these components will now be described.

End user device 102 is intended to represent a processor-based electronic device that is capable of executing one or more software applications that are installed thereon. By way of example only and without limitation, end user device 102 may comprise a personal computer, a laptop computer, a tablet computer, a smart phone, a smart television, a gaming console, a personal media player, a personal digital assistant, an embedded device, or the like. Although only a single end user device 102 is shown in FIG. 1, it is to be understood that system 100 may include any number of end user devices, including hundreds, thousands, hundreds of thousands, or even millions of end user devices.

As further shown in FIG. 1, end user device 102 includes an operating system 112, a user interface 114, an antimalware program 116, at least one application package 118. Application package 118 is installed in memory of end user device 102 and includes an application 122. In one embodiment, application 122 comprises a file that includes object code that can be executed by a processing unit of end user device 102, thereby causing certain operations to be performed, wherein the type of operations performed will vary depending upon how the application is programmed. Application 122 may represent, for example and without limitation, a telephony application, an e-mail application, a messaging application, a Web browsing application, a calendar application, a utility application, a game application, a social networking application, a music application, a productivity application, a lifestyle application, a reference application, a travel application, a sports application, a navigation application, a healthcare and fitness application, a news application, a photography application, a finance application, a business application, an education application, a weather application, a books application, a medical application, or the like.

In addition to application 122, application package 118 also includes other files 124 associated with application 122. For example and without limitation, such other files may include an image or tile that can be used to represent application 122 in the context of a graphical user interface (GUI) of end user device 102, one or more resources that may be used by application 122, and a package manifest that describes the contents of application package 118 in a format that can be understood by operating system 112. However, these examples are not intended to be limiting and other files 124 may include additional files and/or different files than those mentioned above.

Application package 118 may be distributed to and/or installed on end user device 102 in a variety of ways, depending upon the implementation. For example, in one embodiment, application package 118 may be downloaded from an application store that is accessible to end user device 102 via a network and then installed thereon by operating system 112. In another embodiment in which end user device 102 is utilized as part of or in conjunction with an enterprise network, application package 118 may also be distributed to end user device 102 by a system administrator using any of a variety of enterprise network management tools and then installed thereon by operating system 112. In yet another embodiment, application package 118 may be installed on end user device 102 by a system builder, such as by an original equipment manufacturer (OEM) or embedded device manufacturer, using any of a variety of suitable system builder utilities. In a further embodiment, an operating system manufacturer may include application package 118 along with an operating system that is installed on end user device 102. In a still further embodiment in which end user device 102 comprises a developer machine, a developer may install application package 118 on end user device 102.

Operating system 112 comprises a set of programs that manage resources and provide common services for applications executing on end user device 102. As shown in FIG. 1, operating system 112 includes application management logic 126. Application management logic 126 is configured to manage applications that have been developed to accord with a particular application model. In accordance with this application model, an application can be distributed to or loaded onto end user device 102 as part of a digitally-signed application package. One example of such an application package was previously described in reference to application package 118. Application management logic 126 is capable of performing such functions as installing an application package to a predetermined area of memory, and performing digital signature checking to ensure the integrity of an application package before allowing the application associated therewith to be launched. Still other functions of application management logic 126 will be described herein.

Applications that have been developed to accord with the particular application model described above may be referred to herein as “modern applications.” Application 122 is intended to represent one example of such a modern application.

User interface 114 is intended to broadly represent any type of interface that can be used to convey information to and/or receive information from a user of end user device 102. In one embodiment, user interface 114 comprises at least a display by which information may be conveyed visually to a user of end user device 102 and at least one input device (such as a touch screen, keypad, keyboard, mouse, or the like), by which the user can enter information into end user device 102.

Antimalware program 116 comprises software that is configured to detect and remove malicious software (“malware”) from end user device 102. Among other features, antimalware program 116 is configured to detect and remove malware from modern applications that accord with the application model discussed above. Thus, antimalware program 116 is configured to scan the content of application packages, such as application package 118, to detect any malicious files included therein, and to render such malicious files harmless. Rendering a malicious file harmless may comprise, for example, modifying the contents of the malicious file (e.g., to repair the contents and/or render the malicious content inert), deleting the malicious file, or deleting the application package that includes the malicious file.

In one embodiment, antimalware program 116 comprises an integrated part of operating system 112 and may be installed therewith. For example, antimalware program 116 may comprise a version of MICROSOFT® WINDOWS° DEFENDER that is included as part of a MICROSOFT® WINDOWS° 8 operating system. Each of these software products is published by Microsoft Corporation of Redmond, Wash. In an alternative embodiment, antimalware program 116 may comprise a stand-alone application that is not an integrated part of operating system 112. In further accordance with this latter embodiment, antimalware program 116 may be published by an entity that is different than the entity that publishes operating system 112. For example, antimalware program 116 may comprise a version of NORTON® ANTIVIRUS, published by Symantec Corporation of Mountain View, Calif., while operating system 112 may comprise a version of the MICROSOFT® WINDOWS° 8 operating system. Of course, these are only examples and are not intended to be limiting.

As mentioned above, end user device 102 is capable of communicating with application support system 104 via network 106. Application support system 104 is intended to represent a system implemented on one or more computers that is configured to at least perform remediation functions with respect to modern applications installed on end user devices, such as end user device 102. In one implementation, application support system 104 comprises a cloud-based application store that is capable of uploading and hosting a plurality of modern applications and of distributing copies of such applications to end user devices, such as end user device 102, via network 106. In another implementation, application support system 104 comprises one or more computers configured to perform network management and support operations in an enterprise network. In still further implementations, application support system 104 comprises some other type of computer-implemented system configured to perform at least malware remediation functions with respect to modern applications installed on end user devices.

Although only a single application support system 104 is shown in FIG. 1, it is possible that system 100 may include multiple application support systems that are configured to support different modern applications. For example, applications downloaded to end user device 102 from an application store may be remediated by contacting an application support system that is part of an application store while applications deployed to end user device 102 by a system administrator may be remediated by contacting an administrative console. To enable such functionality, application management logic 126 and/or application package 118 may be configured to track an original package source.

Network 106 is intended to represent any type of network or combination of networks suitable for facilitating communication between end user devices, such as end user device 102, and application support system 104. Network 106 may include, for example and without limitation, a wide area network, a local area network, a private network, a public network, a packet network, a circuit-switched network, a wired network, and/or a wireless network.

Taken together, various elements of system 100 can operate to provide a complete application remediation function for modern applications, such as application 122, that accord to the particular application model described above. These elements include at least antimalware program 114, operating system 112 (including application management logic 126), user interface 114, and application support system 104. The manner in which these elements operate to help perform the aforementioned application remediation function will now be further described.

Antimalware program 116 is configured to scan and detect applications that constitute malware or include malware and to subsequently identify and apply an appropriate remediation action when malware is detected. As noted above, such remediation actions may include, but are not limited to, modifying the contents of a malicious file (e.g., to repair the contents and/or render the malicious content inert), deleting a malicious file, or deleting an application package that includes a malicious file. During scanning, antimalware program 116 is capable of distinguishing a modern application, such as application 122, from a non-modern application. Hence, in an embodiment in which metadata is provided for a modern application (e.g., as part of application package 118), antimalware program 116 may leverage such metadata to conduct heuristics in order to detect malicious behavior. Such metadata may include, for example, an identification of the files included in application package 118. Furthermore, antimalware program 116 may utilize such application metadata during runtime to identify anomalous behavior of a modern application such as exploits or backdoors. As will be discussed further herein, antimalware program 116 may also be configured to send telemetry to an antimalware-specific reporting infrastructure after the remediation phase is complete. Such telemetry may include, but is not limited to, information about malware that was detected, what actions were taken by antimalware program 116 to remediate the malware, the and results of any such actions. Such telemetry may be anonymized for security and privacy reasons.

Operating system 112, including application management logic 126, is configured to interact with antimalware program 116 for the purpose of facilitating remediation operations beyond those that can be provided by antimalware program 116 alone. For example, operating system 112 may be configured to facilitate the establishment of a connection between end user device 102 and application support system 104 in response to determining that antimalware program 114 has detected and attempted to remediate a malicious modern application, so that application support system 104 can perform further remediation operations to be described herein. Operating system 112 may also provide its own telemetry to application support system 104 concerning the malicious modern application. To enable interaction with an antimalware program such as antimalware program 116, operating system 112 may provide suitable application programming interfaces (APIs), some of which will be described further herein.

Application management logic 126 is also configured to utilize user interface 114 to notify a user of end user device 102 when antimalware program 114 has detected and attempted to remediate a malicious modern application. Application management logic 126 may also utilize user interface 114 to provide details to the user about the malicious application as well as to provide instructions to the user concerning how the user may interact with application support system 104 to facilitate further remediation operations. Accordingly, application management logic 126 may utilize user interface 114 to provide a complete end-to-end user experience in relation to remediation malicious modern applications.

Application support system 104 is configured to perform a number of remediation operations that can extend beyond those performed by antimalware program 116 and that may be deemed vital to providing full antimalware support for a modern application. For example, as part of remediating a malicious modern application, it is possible that antimalware program 116 may modify or remove one or more files in the application package associated therewith. In certain instances, this file deletion/modification may leave the application in a non-functioning state (e.g., because the file deletion/modification rendered the application inoperable and/or because the file deletion/modification caused the application package to fail digital signature checking). To address this issue, application support system 104 can be configured to replace one or more files of the application package, such that the application will be returned to a functioning state.

In an embodiment in which application support system 104 comprises an application store that enables end users to purchase and download applications, application support system 104 may also be configured to provide a user with a refund for a malicious modern application.

Application support system 104 may also provide corrective guidance to a user of end user device 102 for handling a malicious modern application identified by antimalware program 116. Such corrective guidance may be transmitted from application support system 104 to end user device 102 and displayed via user interface 114. The content of the guidance provided by application support system 104 may determined, at least in part, based on telemetry received from operating system 112, antimalware program 116, or an antimalware-specific reporting infrastructure associated with antimalware program 116. Application support system 104 may also provide other information to the user that is useful for repairing a modern application or obtaining a refund.

In an embodiment in which application support system 104 comprises a system that is capable of distributing modern applications (e.g., an application store), application support system 104 may be configured to utilize the aforementioned telemetry concerning a malicious modern application to perform operations that will safeguard other users who may download modern applications. For example, upon receiving telemetry about a particular application package that includes at least one malicious component, application support system 104 may: scan, delete, repair and/or prevent end users from downloading a copy of the particular application package that is stored by application support system 104; scan, delete, prevent end users from downloading, and/or prohibit uploading of other application packages published by the same entity that published the particular application package; and/or scan, delete, repair, prevent end users from downloading, and/or prohibit uploading of other application packages having similar characteristics to the particular application package. Upon becoming aware of a malicious modern application, application support system 104 may also send commands or other messages to one or more end user devices upon which the application is installed to cause the malicious modern application to be disabled and/or to cause all or a part of the application package associated with the malicious modern application to be removed.

Application support system 104 may also include antimalware functionality that is configured to perform malware scanning and detection operations with respect to applications that have been stored for distribution by application support system 104. When application support system 104 becomes aware that a particular malicious modern application is stored thereon, it may perform actions similar to those described in the preceding paragraph to protect users who may download or have downloaded a malicious modern application. Such antimalware functionality may comprise an integrated part of application support system 104 as noted above or may also comprise part of separate service that may be used or invoked by by application support system 104 as well as other systems. In the latter scenario, the antimalware functionality may provide telemetry to application support system 104 that will cause application support system 104 to perform actions similar to those described in the preceding paragraph.

The following section will describe various scenarios and methods for performing malware remediation of a modern application that is installed on an end user device, wherein such scenarios and methods will be described in the context of system 100 of FIG. 1. However, it is noted that system 100 is described herein by way of example only. Based on the teachings provided herein, persons skilled in the relevant art(s) will appreciate that the scenarios and methods described herein may be implemented by systems other than that shown in FIG. 1.

### III. Example Scenarios and Methods for Performing Malware Remediation of a Modern Application

Two scenarios by which system 100 may operate to remediate a modern application that is determined to be malicious will now be described. These scenarios are described herein merely to illustrate how certain exemplary embodiments of system 100 may operate and are not intended to be limiting. Persons skilled in the relevant art(s) will readily appreciate that system 100 may perform remediation of a modern application in numerous ways other than those that will be described in the following scenarios.

In accordance with a first scenario, a legitimate modern application becomes infected by malware. Such an infection may result, for example, from a cross-infection vector and may result in the disabling of the modern application. In accordance with one embodiment of system 100, when antimalware program 116 discovers the infection, it attempts to repair the relevant files(s) in the application package so that the application can be returned to its original state. Subsequently, the content associated with the application is compared to that identified in a manifest originally included as part of the application package and, if the content does not match, a new copy of the application package can be downloaded from application support system 104. During this process, a user can be apprised via user interface 114 of the infection and the steps that are being carried out to restore end user device 102 to a good state.

In accordance with a second scenario, a malicious modern application is unknowingly packaged and distributed to end user device 102 via an application store or other entity. Such a scenario may conceivably occur due to the rapid pace of malware as seen in certain application stores. In accordance with one embodiment of system 100, antimalware program 116 may be provided with a signature for the particular piece of malware as part of a standard signature update process. Antimalware program 116 may then use the signature to detect and remediate the infection since, as discussed above, antimalware program 116 is designed to operate on applications that accord with the modern application model. For example, antimalware program 116 may perform scanning, in part, using metadata provided as part of the application package. Also, during application runtime, antimalware program 116 may use such metadata to detect anomalous behaviors such as attempts to exploit a good application or the performance of hidden functionality such as a backdoor.

In further accordance with this second scenario, when an infection is detected, rather than just removing or modifying the files deemed to be infected (which could leave the application in a broken state for reasons previously described), antimalware program 116 determines that the application is a modern application and, based on such determination, interacts with operating system 112 so that the operating system 112 (including application management logic 126) can facilitate further remediation actions. Such further remediation actions may include for example, providing information about the remediation process to the user via user interface 114, sending telemetry to application support system 104, facilitating the establishment of a connection between end user device 102 and application support system 104 so that application support system 104 can perform operations such as replacing all or part of the application package or issuing a refund for the application, and so on. Antimalware program 116 may also provide its own telemetry to an antimalware-specific reporting infrastructure.

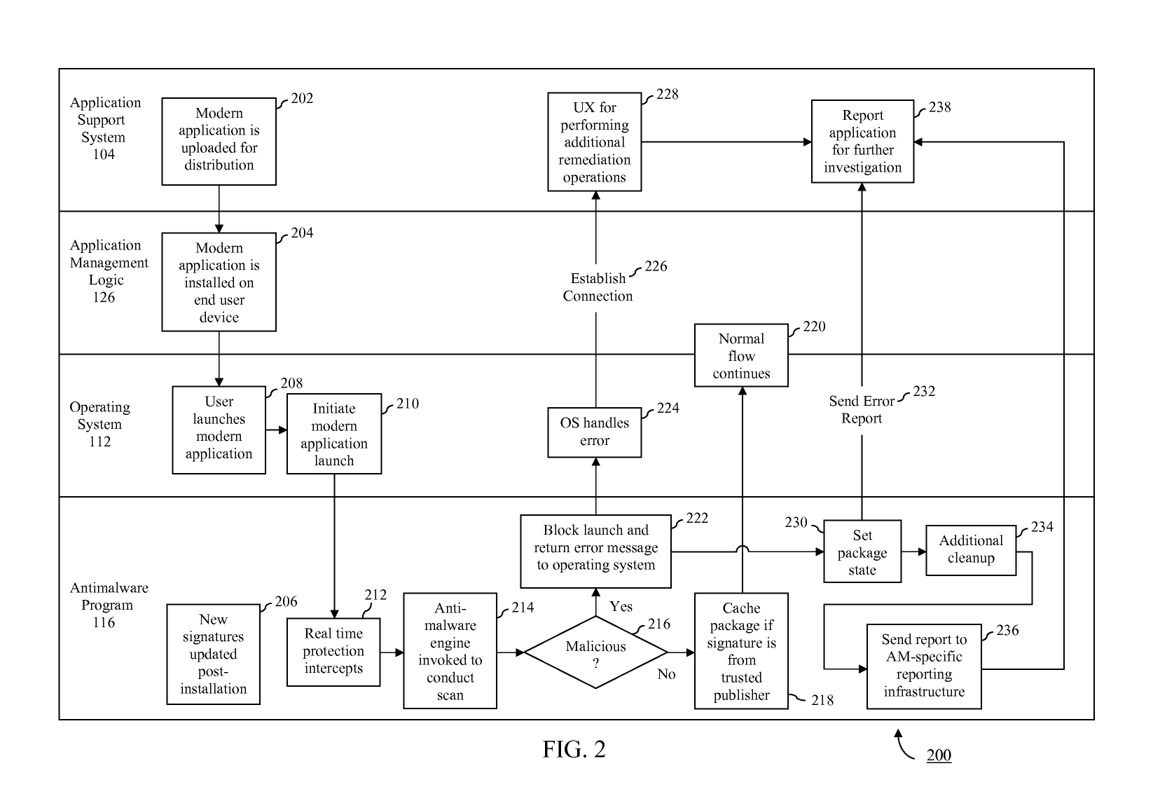

Another method by which system 100 may perform malware remediation of a modern application will now be described in reference to flowchart 200 of FIG. 2. In particular, flowchart 200 is intended to represent a remediation process that may occur when a malicious application that is installed on end user device 102 is launched by a user thereof. Various steps of flowchart 200 are performed by antimalware program 116, operating system 112, application management logic 126 within operating system 126, and application support system 104. To help distinguish which components perform which steps, a separate row has been assigned to each component in FIG. 2. When a step appears within a given row, it is to be understood that the step is performed by the component associated with that row.

As shown in FIG. 2, the method of flowchart 200 begins at step 202, in which a modern application is uploaded to application support system 104 for distribution thereby to end user devices. For the purposes of this particular example, it is to be assumed that application support system 104 comprises a cloud-based application store or some other entity that is capable of uploading, hosting and distributing modern applications to end user devices. At step 204, the modern application is downloaded from application support system 104 and installed on end user device 102 by application management logic 126. In accordance with one embodiment, installing the modern application comprises receiving and decompressing a compressed application package associated with the modern application and storing the contents thereof in a predetermined location in local memory of end user device 102. However, this is only an example and various other techniques may be used to install the modern application on end user device 102.

As previously noted, there are a variety of other methods by which a modern application may be installed on end user device 102 that are not shown in FIG. 2. For example, in an enterprise environment, the modern application may be distributed to end user device 102 for installation thereon by a system administrator using any of a variety of enterprise network management tools. In a further embodiment, the modern application may be installed on end user device 102 by a system builder, such as by an OEM or embedded device manufacturer, using any of a variety of suitable system builder utilities. In still further embodiments, the modern application may be installed on end user device 102 as part of the installation of an operating system that includes the modern application, or may be installed on end user device 102 by a developer as part of a development process. Regardless of how the modern application is installed on end user device 102, the remainder of the process flow shown in FIG. 2 may be performed to determine if the modern application is malicious and to remediate the modern application if it is determined to be malicious.

At step 206, after the modern application has been installed, a collection of signatures used by antimalware program 116 to detect malware is updated to include one or more new signatures. As will be appreciated by persons skilled in the relevant art(s), such update process may occur automatically (e.g., on a periodic basis and/or in response to certain events) and/or may be initiated by a user of end user device 102. In a case where the modern application is malware or becomes infected with malware, step 206 may comprise adding a signature associated with such malware, thereby enabling detection thereof by antimalware program 116.

The new signatures obtained during step 206 may be obtained or received from, for example, a network-accessible server maintained by a publisher of antimalware program 116. Still other methods may be used to provide new signatures for use by antimalware program 116.

At step 208, a user of end user device 102 interacts with operating system 112 to launch the modern application. This step may comprise, for example, selecting and interacting with a graphical representation of the modern application (e.g., a tile or icon that represents the modern application) from a start screen or other GUI managed by operating system 112. As another example, this step may comprise automatically launching the modern application in response to a user opening a document or file having a file extension that is associated with the modern application. As will be appreciated by persons skilled in the relevant art(s), still other methods may be used to launch the modern application.

In response to the user launching the modern application during step 208, operating system 112 initiates a modern application launch process as shown in step 210. At step 212, real time protection interception associated with antimalware program 116 detects the launch process and, in response, invokes an antimalware engine in step 214 to conduct a scan of the modern application prior to launch. Scanning the modern application may comprise, for example, scanning each file in the application package associated with the modern application.

At decision step 216, antimalware program 116 determines whether the modern application being launched is malicious. This step may comprise determining if any of the malware signatures included in a signature database of antimalware program 116 matches any content included in one or more files of the modern application package. However, this is only one example, and persons skilled in the relevant art(s) will appreciate that a variety of malware detection techniques other than or in addition to signature-based detection may be used.

As shown in FIG. 2, if antimalware program 116 determines in decision step 216 that the modern application is not malicious, then control flows to step 218. At step 218, if antimalware program 116 determines that an entity that digitally signed the modern application package is a trusted publisher, then antimalware program 116 adds a unique identifier of the modern application package to a cache stored in local memory of end user device 102. The unique identifier may comprise, for example, the digital signature of the modern application package. This cache can be subsequently accessed by antimalware program 116 when determining whether a modern application package is to be scanned. If the unique identifier of a modern application package already exists in the cache, then antimalware program 116 does not need to re-scan any of the files in the modern application package. This per-package caching scheme can provide a significant performance boost as it enables antimalware program 116 to avoid re-scanning of all the contents of an application package after each signature update, if it is received from a trusted source.

An alternate approach to caching a unique identifier of the modern application package as a whole would be to individually cache identifiers of the components of the modern application package. One advantage of such an approach would be that the cache could then be shared between modern and non-modern applications, and future scanning decisions would not require first determining package membership, which could be expensive.

After step 218, the normal flow of execution of the modern application continues as shown at step 220.

As further shown in FIG. 2, if antimalware program 116 determines in decision step 216 that the modern application is malicious, then control flows to step 222. During step 222, antimalware program 116 blocks the modern application from being launched and passes an error message to operating system 112. In one embodiment, antimalware program 116 passes such an error message to operating system 112 using an API provided by operating system 112. The error message passed to operating system 112 may include additional information. Such additional information may include, for example, a product name associated with the modern application, product brand images associated with the modern application, or the like.

In response to receiving the error message sent by antimalware program 116 during step 222, operating system 112 handles the error as shown at step 224. In one embodiment, handling of the error by operating system 224 includes establishing a connection 226 to application support system 104. Establishing the connection may comprise, for example and without limitation, automatically establishing a connection to application support system 104, automatically launching an application store application on end user device 102 that establishes a connection to application support system 104, or requesting that a user initiate the establishment of a connection to application support system 104.

Once a connection has been established between end user device 102 and application support system 104, application support system 104 can provide a user experience by which additional remediation operations can be performed, as shown in step 228. As discussed elsewhere herein, such remediation operations may include, but are by no means limited to, replacing all or part of the application package installed on end user device 102 so that a user thereof is able to obtain a fully-repaired version of the modern application or issuing a refund to the user when repairing the modern application is not possible. Such remediation operations may also include issuing instructions to application management logic 126 to disable the modern application and/or to remove all or part of the application package associated with the modern application, to the extent these operations haven't already been performed. Still further, such remediation operations may include sending a message to end user device 102 requesting that a user thereof uninstall the modern application. Yet other remediation operations may be performed.

Prior to, during, and/or after the performance of these additional remediation operations, application management logic 126 may utilize user interface 114 to provide information to a user of end user device 102. Such information may serve to notify the user that there is a problem with the malicious modern application and to provide guidance to the user about how the malicious modern application may be further remediated. Such information may also serve to solicit input from the user or to cause the user to perform one or more actions that are necessary to carry out additional remediation.

During step 238, application support system 104 may report the modern application for further investigation based upon at least information about the modern application that was acquired during the user experience of step 228. Application support system 104 may perform a wide variety of actions based upon such information. For example, upon receiving information about a particular modern application, application support system 104 may: scan, delete, repair and/or prevent end users from downloading a copy of the particular modern application that is hosted by application support system 104; scan, delete, prevent end users from downloading, and/or prohibit uploading of other modern applications published by the same entity that published the particular modern application; and/or scan, delete, repair, prevent end users from downloading, and/or prohibit uploading of other modern applications having similar characteristics to the particular modern application package (e.g., modern applications that include the same or similar code, that utilize the same or similar resources, that interact with the same or similar entities, or the like). Application support system 104 may also send commands or other messages to one or more end user devices upon which the particular modern application is installed to cause the particular modern application to be disabled and/or to cause all or a part of the application package associated with the particular modern application to be removed.

As additionally shown in FIG. 2, after antimalware program 116 has blocked the malicious modern application from being launched and has passed an error message to operating system 112 during step 222, antimalware program 116 then sets a state of the application package associated with the malicious modern application to indicate that the application package is in a bad state (e.g., an infected state or inoperable state). By setting the state of the application package in this manner, antimalware program 116 can signal to operating system 112 that there is a problem with the modern application. The state of the application package may be stored in a predefined area of local memory of end user device 112 that is known to at least operating system 112. In one embodiment, antimalware program 116 causes the state of the application package to be changed by invoking an API made available by operating system 112.

Once operating system 112 determines that the state of an application package has been set to bad by antimalware program 116, operating system 112 can then manage the modern application associated with the application package accordingly. For example, operating system 112 may provide an indication to a user of end user device 102 that there is a problem with the modern application. Such indication may comprise, for example, a visual indication provided via a GUI of end user device 102 (e.g., a “glyph” or other visual indicator may be placed on a tile or icon that represents the modern application in a start screen of end user device 102). Furthermore, during any subsequent attempt to launch the modern application, operating system 112 may block execution of the application and establish a connection to application support system 104 to facilitate remediation of the modern application along the lines discussed above in reference to step 228. As will be appreciated by persons skilled in the relevant art(s), operating system 112 may perform still further actions to manage a malicious modern application once operating system 112 has determined that the state of the application package associated therewith has been set to bad by antimalware program 116.

Additionally, once operating system 112 determines that the state of an application package has been set to bad by antimalware program 116, operating system 112 can provide telemetry to application support system 104 concerning the malicious modern application as shown at step 232. The telemetry provided by operating system 112 can include a variety of information relating to the malicious modern application, such as an identifier of the malicious modern application and/or the application package associated therewith, an identifier of one or more components of the application package that were determined to be malicious, information concerning when the application package was installed, information concerning a source of the application package, information about the state of the malicious modern application and/or operating system 112, and the like. Such telemetry may also include information about the malware that was detected, what actions were taken by antimalware program 116 to remediate the malware, and information concerning whether such actions were successful. In accordance with one embodiment, operating system 112 provides an API by which antimalware program 116 may provide information about the detected malware to operating system 112 and about actions taken by antimalware program 116 to remediate such malware. Operating system 112 may then relay this information to application support system 104.

Upon receiving such telemetry about a particular modern application, application support system 104 may perform a wide variety of actions including any of the various corrective or preventative actions described above in reference to step 238 to safeguard other end users.

After antimalware program 116 has set the application package state as shown at step 230, antimalware program 116 then performs additional clean-up tasks as shown at step 234. These additional cleanup tasks may comprise tasks that impact software components stored or installed on end user device other than the components associated with the malicious modern application. For example, such tasks may include removing registry keys or modifying or deleting files that are not part of the application package associated with the malicious modern application. Performing such additional tasks may be necessary, for example, when the malware affecting the modern application is part of a larger systemic infection of the software on end user device 102.

After performing the additional cleanup tasks at step 234, antimalware program 116 may also send its own telemetry (e.g., one or more error reports) concerning the detected malware to an antimalware-specific reporting infrastructure associated with antimalware program 116 to facilitate further analysis and understanding thereof. Such telemetry may include, for example, an identifier and/or description of the malware that was detected, what files were affected, what actions were taken by antimalware program 116 to remediate the malware, and/or whether such actions were successful, although these are merely examples. In an implementation in which antimalware program 116 comprises MICROSOFT® WINDOWS™ DEFENDER, the antimalware-specific reporting infrastructure may comprise part of the MICROSOFT® ACTIVE PROTECTION SERVICE network, although this is only an example. As further shown in FIG. 2, any results obtained by analyzing the telemetry provided to the antimalware-specific reporting infrastructure can be shared with application support system 104 to facilitate the investigation of a malicious modern application and may result in the performance of any of the various corrective or preventative actions described above in reference to step 238 to safeguard other end users. The transfer of such results to application support system 104 may be carried out automatically or manually depending upon the implementation. Since application support system 104 can obtain telemetry from both operating system 112 and antimalware program 116 in accordance with certain embodiments, application support system 104 may advantageously obtain a more comprehensive understanding of the malware that has impacted the modern application.

As noted above, flowchart 200 of FIG. 2 is intended to represent a remediation process that may occur when a malicious application installed on end user device 102 is launched by a user thereof. However, many of the steps shown in FIG. 2 may also be performed as a result of antimalware scanning operations that occur at other times. For example, antimalware program 116 may determine that a modern application is malicious during the course of performing a background file-scanning operation, wherein such background file-scanning operation may be configured to occur periodically or may be launched in response to some event (e.g., system startup or user activation). In accordance with such a scenario, antimalware program 116 may perform all of steps 230, 232, 234 and 236 in response to detecting the malicious application. By virtue of the setting of the application package state in step 230, operating system 112 may then ensure that the malicious application is not executed when subsequently launched, and instead establish a connection to application support system 104 to facilitate remediation of the malicious application.

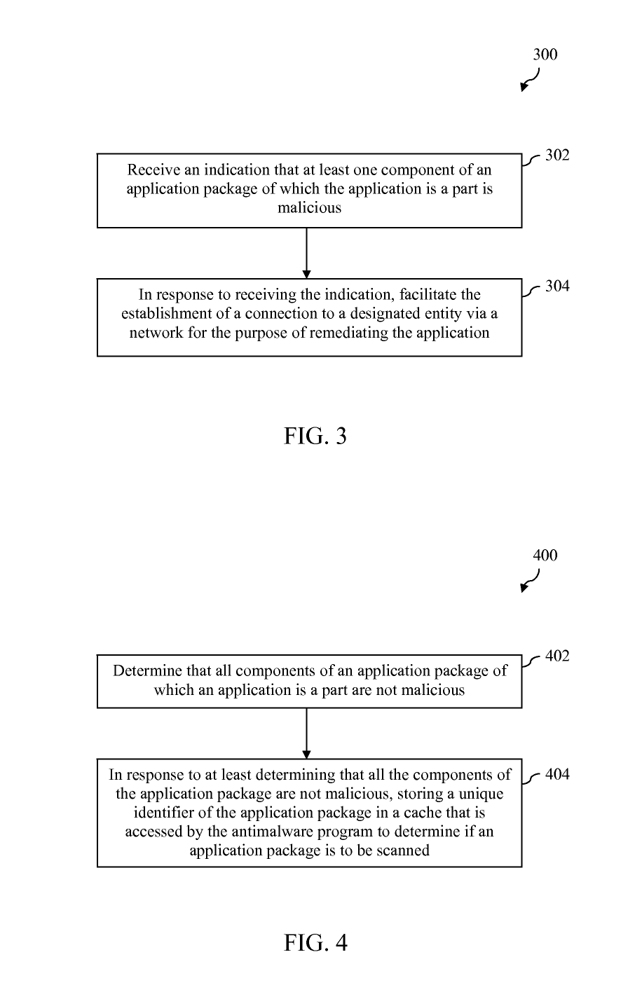

FIG. 3 depicts a flowchart 300 of a more generalized process for performing malware remediation of a modern application that is installed on an end user device in accordance with an embodiment. The steps of flowchart 300 may be performed, for example, by an operating system executing on the end user device. For example, the steps of flowchart 300 may be performed by operating system 112 executing on end user device 102 as described above in reference to FIG. 1, although the method is not limited to that implementation.

As shown in FIG. 3, the method of flowchart 300 begins at step 302 in which the operating system receives an indication that at least one component of an application package of which the modern application is a part is malicious.

As discussed above, in one embodiment, such a notification may be received from an antimalware program executing on the end user device, such as antimalware program 116 described above in reference to FIG. 1. For example, receiving the indication from the antimalware program may comprise receiving a message from the antimalware program indicating that the antimalware program blocked execution of the modern application in response to detecting that the at least one component of the application is malicious. Alternatively or additionally, receiving the indication from the antimalware program may comprise receiving a request from the antimalware program to change a state associated with the application package to reflect that the at least one component of the application package is malicious. In certain embodiments, the operating system exposes one or more APIs by which such messages and requests may be received from the antimalware program.

It is noted that the notification received by the operating system in step 302 need not originate from an antimalware program. For example, such notification may emanate from a component of the operating system itself, from some other program or process executing on the end user device, or even from an application support system, such as application support system 104 described above in reference to FIG. 1. Thus, the notification may be received from a remote computer that is connected to the end user device via a network.

At step 304, in response to receiving the indication in step 302, the operating system facilitates the establishment of a connection to a designated entity via a network for the purpose of remediating the modern application. As discussed above, the designated entity may comprise an application support system, such as application support system 104 described above in reference to FIG. 1. Thus, in accordance with various embodiments, the designated entity may comprise a consumer application store, an enterprise application store, a computer or system used by an enterprise network administrator, or some other computer-implemented entity or system that can be accessed by the end user device via a network.

Depending upon the implementation, facilitating the establishment of the connection to the designated entity in step 304 may comprise automatically establishing the connection to the designated entity, automatically launching an application (such as an application store application) on the end user device that establishes the connection to the designated entity, or even notifying a user of the end user device that the user should contact an administrator associated with the designated entity so that the administrator can establish the connection. Still other methods of facilitating the establishment of the connection to the designated entity are contemplated.

There are various ways in which the designated entity may remediate the modern application, many of which were previously described. For example, the designated entity may replace all or part of the application package associated with the modern application that is stored on the end user device. The designated entity may also cause a refund to be issued for the modern application. The designated entity may also cause the modern application to be disabled and/or cause all or a part of the application package associated with the modern application to removed from the end user device to the extent these operations were not already performed. The designated entity may also send a message to the end user device requesting that a user thereof uninstall the application. Still other remediation activities may be performed by the designated entity.

In addition to facilitating the establishment of a connection to the designated entity in response to receiving the indication as shown in step 304, the operating system may further block the execution of the modern application. Such blocking may also be carried out by an antimalware program that is executing on the end user device, either alone or in conjunction with the operating system.

The method of flowchart 300 may further include any number of additional steps that are not shown in FIG. 3. For example, the method may include sending a report concerning the malicious component(s) from the operating system to the designated entity in response to receiving the indication. Various examples of the type of information that may be passed as telemetry from the operating system to the designated entity were described above in reference to flowchart 200 of FIG. 2

The method of flowchart 300 may further include sending a report concerning the malicious component(s) from an antimalware program that generated the indication to the designated entity and/or to an antimalware-specific reporting infrastructure. Various examples of the type of information that may be passed as telemetry from the antimalware program to the designated entity and/or to the antimalware-specific reporting infrastructure were described above in reference to flowchart 200 of FIG. 2.

The method of flowchart 300 may still further include providing a visual indication on a GUI of the end user device that there is a problem with the modern application. As previously noted, such a visual indication may comprise, for example, a “glyph” or other visual indicator may be placed on a tile or icon that represents the modern application in a start screen of the end user device. However, other visual indications may be used.

FIG. 4 depicts a flowchart 400 of a package-level caching process that may be used to improve the performance of an antimalware program executing on an end user device in accordance with an embodiment. The steps of flowchart 400 may be performed, for example, by antimalware program 116 executing on end user device 102 as described above in reference to FIG. 1, although the method is not limited to that implementation.

As shown in FIG. 4, the method of flowchart 400 begins at step 402 in which the antimalware program determines that all components of an application package of which a modern application is a part are not malicious.

At step 404, in response to at least determining that all the components of the application package are not malicious, the antimalware program stores a unique identifier of the application package in a cache. The unique identifier may comprise, for example, a digital signature of the application package. This cache can then be subsequently accessed by the antimalware program when determining whether a modern application package is to be scanned. If the unique identifier of a modern application package already exists in the cache, then the antimalware program does not need to re-scan any of the files in the modern application package.

In one embodiment, the antimalware program stores the unique identifier of the application package in the cache in response to determining that (a) all the components of the application package are not malicious and (b) that the application package was published by a trusted publisher. In accordance with such a package-level caching scheme, the antimalware program can avoid re-scanning of all the contents of an application package received from a trusted source.

As previously noted, step 404 may alternatively comprise storing unique identifiers of each of the components of the application package in a cache.

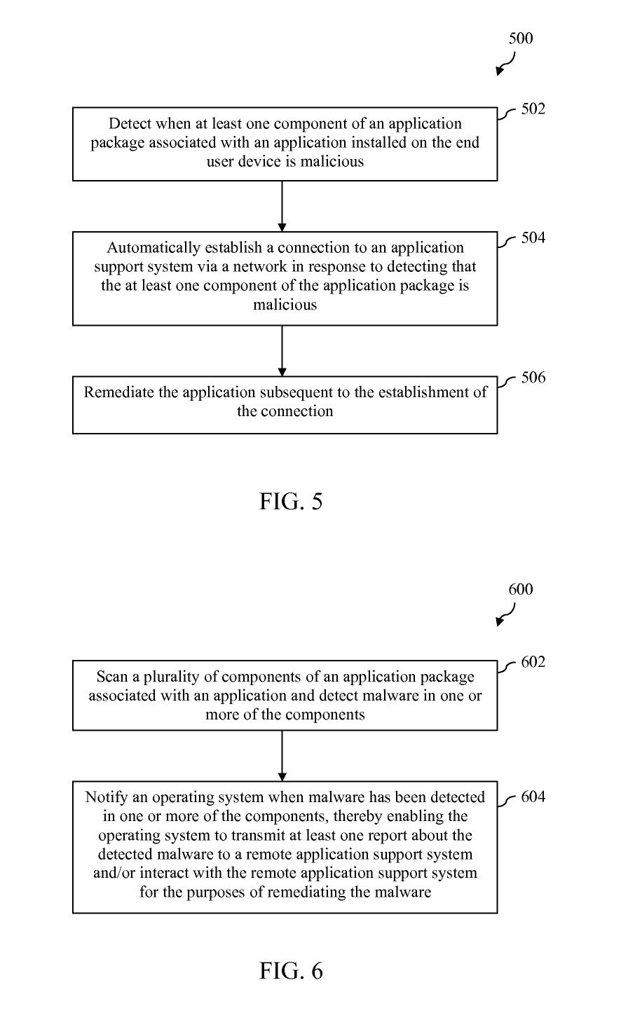

FIG. 5 depicts a flowchart 500 of a method that may be executed by a computer-implemented system for remediating a malicious modern application in accordance with an embodiment. The steps of flowchart 500 may be performed, for example, by end user device 102 and application support system 104 as described above in reference to FIG. 1, although the method is not limited to that implementation.

As shown in FIG. 5, the method of flowchart 500 begins at step 502, in which an end user device detects when at least one component of an application package associated with a modern application installed on the end user device is malicious.

At step 504, the end user device automatically establishes a connection to an application support system via a network in response to detecting that the at least one component of the application package is malicious.

At step 506, the application support system remediates the modern application subsequent to the establishment of the connection during step 504. As previously noted, there are various ways in which the application support system may remediate the modern application. For example, the application support system may replace all or part of the application package associated with the modern application that is stored on the end user device. The application support system may also cause a refund to be issued for the modern application. The application support system may also cause the modern application to be disabled and/or cause all or a part of the application package associated with the modern application to removed from the end user device to the extent these operations were not already performed. The application support system may also send a message to the end user device requesting that a user thereof uninstall the modern application. Still other remediation activities may be performed by the designated entity.

The method of flowchart 500 may further include any number of additional steps that are not shown in FIG. 5. For example, the method may include the application support system receiving one or more reports concerning the malicious component(s) from the end user device and/or from an antimalware-specific reporting infrastructure. The method may still further include the application support system performing one or more of the following actions in response to receiving such report(s): scanning, deleting, repairing and/or preventing end user devices from downloading a copy of the application package associated with the modern application that is stored by the application support system; scanning, deleting, repairing, preventing the end user devices from downloading, and/or prohibiting uploading of other application packages published by an entity that published the application package associated with the modern application; and scanning, deleting, repairing, preventing the end user devices from downloading, and/or prohibiting uploading of other application packages having similar characteristics to the application package associated with the modern application.

The method of flowchart 500 may further include scanning a second application package that is hosted or otherwise stored by the application support system, wherein the second application is associated with a second application that is installed on the end user device. In response to detecting that at least one component of the second application package is malicious, the application support system may send a message or other information to the end user device that causes the end user device to disable the second application.

FIG. 6 depicts a flowchart 600 of a method that may be performed by an antimalware program executing on an end user device for remediating a malicious modern application in accordance with an embodiment. The steps of flowchart 600 may be performed, for example, by antimalware program 116 executing on end user device 102 as described above in reference to FIG. 1, although the method is not limited to that implementation.

As shown in FIG. 6, the method of flowchart 600 begins at step 602 in which the antimalware program scans a plurality of components (e.g., files) of an application package associated with a modern application and detects malware in one or more of the components.

At step 604, the antimalware program notifies an operating system executing on the same end user device when malware has been detected in one or more of the components, thereby enabling the operating system to transmit at least one report about the detected malware to a remote application support system and/or interact with the remote application support system for the purpose of remediating the malware.

The method of flowchart 600 may further include any number of additional steps that are not shown in FIG. 6. For example, the method of flowchart 600 may further include the antimalware program utilizing metadata associated with the modern application to perform runtime monitoring of the modern application, wherein the runtime monitoring may include detecting attempts to exploit a second modern application installed on the end user device and/or detecting hidden functionality (e.g., backdoors).

### IV. Example Computer System Implementations

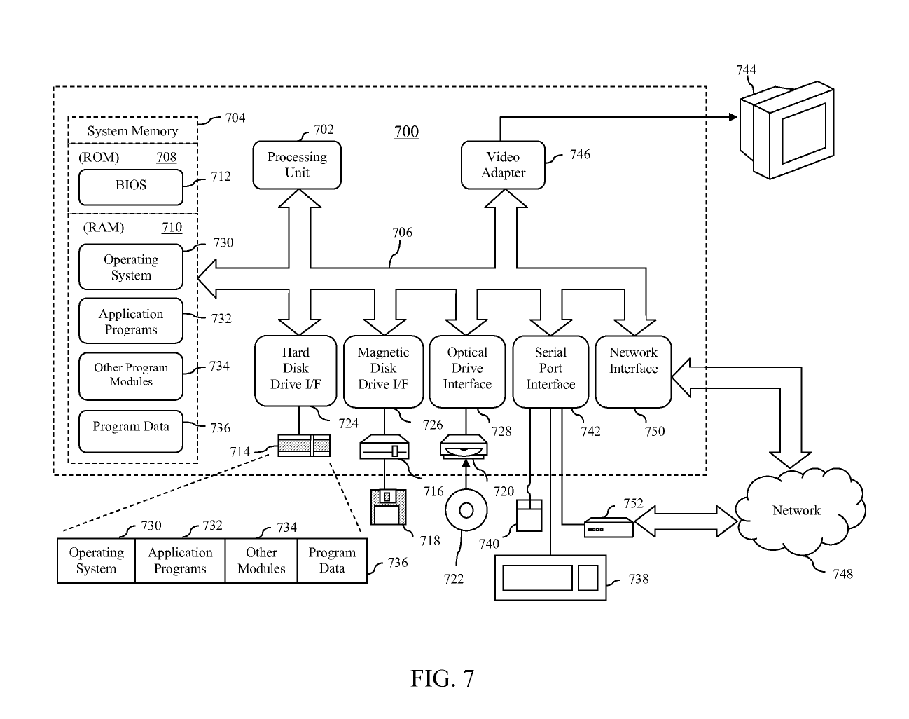

FIG. 7 depicts an example computer system 700 that may be used to implement various embodiments described herein. For example, computer system 700 may be used to implement either or both of end user device 102, application support system 104, as well as any sub-components thereof. The description of computer system 700 provided herein is provided for purposes of illustration, and is not intended to be limiting. Embodiments may be implemented in further types of computer systems, as would be known to persons skilled in the relevant art(s).

As shown in FIG. 7, computer system 700 includes a processing unit 702, a system memory 704, and a bus 706 that couples various system components including system memory 704 to processing unit 702. Processing unit 702 may comprise one or more processors or processing cores. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer system 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, BLU-RAY™ disk or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 730, one or more application programs 732, other program modules 734, and program data 736. In accordance with various embodiments, the program modules may include computer program logic that is executable by processing unit 702 to perform any or all of the functions and features of end user device 102, application support system 104, as well as any sub-components thereof, as described elsewhere herein. The program modules may also include computer program logic that, when executed by processing unit 702, performs any of the steps or operations shown or described in reference to FIGS. 2-6.

A user may enter commands and information into computer system 700 through input devices such as a keyboard 738 and a pointing device 740. Other input devices (not shown) may include a microphone, joystick, game controller, scanner, or the like. In one embodiment, a touch screen is provided in conjunction with a display 744 to allow a user to provide user input via the application of a touch (as by a finger or stylus for example) to one or more points on the touch screen. These and other input devices are often connected to processing unit 702 through a serial port interface 742 that is coupled to bus 706, but may be connected by other interfaces, such as a parallel port, game port, or a universal serial bus (USB).

A display 744 is also connected to bus 706 via an interface, such as a video adapter 746. In addition to display 744, computer system 700 may include other peripheral output devices (not shown) such as speakers and printers.

Computer system 700 is connected to a network 748 (e.g., a local area network or wide area network such as the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable medium” are used to generally refer to non-transitory media such as ROM 708 and RAM 710 used to implement system memory 704, the hard disk associated with hard disk drive 714, removable magnetic disk 718, removable optical disk 722, as well as other media such as flash memory cards, digital video disks, and the like.

As noted above, computer programs and modules (including application programs 732 and other program modules 734) may be stored on ROM 708, RAM 710, the hard disk, magnetic disk, or optical disk,. Such computer programs may also be received via network interface 750 or serial port interface 742. Such computer programs, when executed by processing unit 702, enable computer system 700 to implement features of embodiments discussed herein. Accordingly, such computer programs represent controllers of computer system 700.

Embodiments are also directed to computer program products comprising software stored on any computer-readable medium. Such software, when executed in one or more data processing devices, causes a data processing device(s) to operate as described herein. Embodiments may employ any computer-useable or computer-readable medium, known now or in the future. Examples of computer-readable mediums include, but are not limited to storage devices such as ROM, RAM, hard drives, floppy disks, CD ROMs, DVD ROMs, zip disks, tapes, magnetic storage devices, optical storage devices, MEMS-based storage devices, nanotechnology-based storage devices, and the like.

In alternative implementations, each of end user device 102 and application support system 104, as well as any sub-components thereof may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### V. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for performing malware remediation of an application that is installed on an end user device, comprising:
performing the following steps by an operating system executing on the end user device:
(a) receiving an indication that at least one component of an application package of which the application is a part is malicious; and
(b) in response to receiving the indication, facilitating the establishment of a connection to a designated entity via a network for the purpose of remediating the application.

2. The method of claim 1, wherein step (b) further comprises blocking execution of the application.

3. The method of claim 1, wherein the designated entity comprises a computer-implemented application store.

4. The method of claim 1, wherein remediating the application comprises at least one of:
causing the application to be disabled;
causing all or a part of the application package to be removed from the end user device;
replacing all or a part of the application package;
issuing a refund for the application; and
sending a message to the end user device requesting that a user thereof uninstall the application.

5. The method of claim 1, wherein step (a) comprises receiving the indication from an antimalware program executing on the end user device.

6. The method of claim 5, wherein receiving the indication from the antimalware program comprises:
receiving a request from the antimalware program to change a state associated with the application package to reflect that the at least one component of the application package is malicious.

7. The method of claim 5, wherein receiving the indication from the antimalware program comprises:
receiving a message from the antimalware program indicating that the antimalware program blocked execution of the application in response to detecting that the at least one component of the application is malicious.

8. The method of claim 5, further comprising:
performing the following steps by the antimalware program executing on the end user device:
determining that all components of a second application package of which a second application is a part are not malicious; and
in response to at least determining that all the components of the second application package are not malicious, storing a unique identifier of the second application package or of each of the components thereof in a cache that is accessed by the antimalware program to determine if an application package or a component thereof is to be scanned.

9. The method of claim 8, wherein the storing step is performed in response to determining that all the components of the second application package are not malicious and to determining that the second application package is published by a trusted publisher.

10. The method of claim 1, wherein step (a) comprises receiving the indication from a remote computer that is connected to the end user device via the network.

11. The method of claim 1, further comprising:
in response to receiving the indication, the operating system sending a report concerning the malicious component(s) to the designated entity.

12. The method of claim 4, further comprising:
the antimalware program sending a report concerning the malicious components to an antimalware-specific reporting infrastructure.

13. The method of claim 1, further comprising:
providing a visual indication on a graphical user interface of the end user device that there is a problem with the application.

14. A system, comprising:
an application support system implemented on one or more computers; and
an end user device that is capable of detecting when at least one component of an application package associated with an application installed on the end user device is malicious and of automatically establishing a connection to the application support system via a network in response to detecting that the at least one component of the application package is malicious;
the application support system being configured to remediate the application subsequent to the establishment of the connection.

15. The system of claim 14, wherein the application support system is configured to remediate the application by performing at least one of:
causing the application to be disabled;
causing all or a part of the application package to be removed from the end user device;
replacing all or a part of the application package;
issuing a refund for the application; and
sending a message to the end user device requesting that a user thereof uninstall the application.

16. The system of claim 14, wherein the application support system is further configured to receive one or more reports concerning the malicious component(s) from the end user device and/or an antimalware-specific reporting infrastructure.

17. The system of claim 16, wherein the application support system is further configured to perform one or more of the follow actions in response to receiving the report(s):
scanning, deleting, repairing and/or preventing end user devices from downloading a copy of the application package stored by the application support system;
scanning, deleting, repairing, preventing the end user devices from downloading, and/or prohibiting uploading of other application packages published by an entity that published the application package; and
scanning, deleting, repairing, preventing the end user devices from downloading, and/or prohibiting uploading of other application packages having similar characteristics to the application package.

18. The system of claim 14, wherein the application support system is further configured to scan a second application package stored by the application support system, the second application package being associated with a second application that is installed on the end user device, and to send a message to the end user device that causes the end user device to disable the second application in response to detecting that at least one component of the second application package is malicious.

19. A computer program product comprising a computer-readable storage device having computer program logic recorded thereon, the computer program logic comprising:
first computer program logic that is executable by a processing unit to scan a plurality of components of an application package associated with an application to determine if the application is malicious; and
second computer program logic that is executable by the processing unit to notify an operating system when it is determined that the application is malicious, thereby enabling the operating system to transmit at least one report about the malicious application to a remote application support system and/or interact with the remote application support system for the purposes of remediating the malicious application.

20. The computer program product of claim 19, wherein the computer program logic further comprises:
third computer program logic that is executable by the processing unit to utilize metadata associated with the application to perform runtime monitoring of the application, wherein the runtime monitoring includes detecting attempts to exploit a second application and/or detecting hidden functionality.
